(19) United States
(12) Patent Application Publication
(10) Pub. No.: US 2014/0092039 A1
(43) Pub. Date: Apr. 3, 2014

(54) Electronic Device, Program and Lock Control Method

(71) Applicant: Kabushiki Kaisha Toshiba, Tokyo (JP)

(72) Inventor: Kei Ito, Kodaira-shi (JP)

(73) Assignee: Kabushiki Kaisha Toshiba, Tokyo (JP)

(21) Appl. No.: 13/952,389

(22) Filed: Jul. 26, 2013

(30) Foreign Application Priority Data
Sep. 28, 2012 (JP) 2012-218791

(51) Int. Cl. G06F 21/36

(52) U.S. Cl. CPC G06F 21/36
USPC 345/173

(57) ABSTRACT

According to one embodiment, an electronic device includes: a display; a touch panel provided on the display; a lock controller configured to shift the electronic device to a locked state and configured to cancel the locked state when a touch input in a predetermined position of the touch panel is detected; and an unlock screen display controller configured to generate an image as a reference of the position of the touch input for cancellation of the locked state, display the image on the display, and control a display form of the image so that the display form corresponding to a first timing is different from the display form corresponding to a second timing.

### CROSS REFERENCE TO RELATED APPLICATION(S)

The application is based upon and claims the benefit of priority from Japanese Patent Application No. 2012-218791 filed on Sep. 28, 2012, the entire contents of which are incorporated herein by reference.

### BACKGROUND

1. Field

An embodiment of the present invention relates to an electronic device, a program and a lock control method.

2. Description of the Related Art

User interfaces based on touch panels have increased in recent years. In a device using a touch panel, unlock control for unlocking the device by user's tracing a predetermined locus/touching a predetermined position with a user's finger on an unlock screen displayed on a screen for unlocking the device has been often used.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a perspective view showing an example of external appearance of an electronic device in an embodiment;

FIG. 2 is a block diagram showing an example of system configuration of the electronic device in the embodiment;

FIG. 3 is a block diagram showing an example of functional configuration in the embodiment;

FIG. 4 is a conceptual view showing an example of an unlock process in the embodiment;

FIGS. 5A to 5C are conceptual views showing examples of an unlock screen in the embodiment;

FIGS. 6A to 6C are conceptual views showing examples of the unlock screen in the embodiment;

FIGS. 7A to 7C are conceptual views showing examples of the unlock screen in the embodiment;

FIGS. 8A and 8B are Conceptual views showing examples of the unlock screen in the embodiment;

FIG. 9 is a flow chart showing an example of an unlock input setting process in the embodiment; and

FIG. 10 is a flow chart showing an example of an unlock process in the embodiment.

### DETAILED DESCRIPTION

An embodiment will be described below with reference to the drawings.

According to one embodiment, an electronic device includes: a display; a touch panel provided on the display; a lock controller configured to shift the electronic device to a locked state and configured to cancel the locked state when a touch input in a predetermined position of the touch panel is detected; and an unlock screen display controller configured to generate an image as a reference of the position of the touch input for cancellation of the locked state, display the image on the display, and control a display form of the image so that the display form corresponding to a first timing is different from the display form corresponding to a second timing.

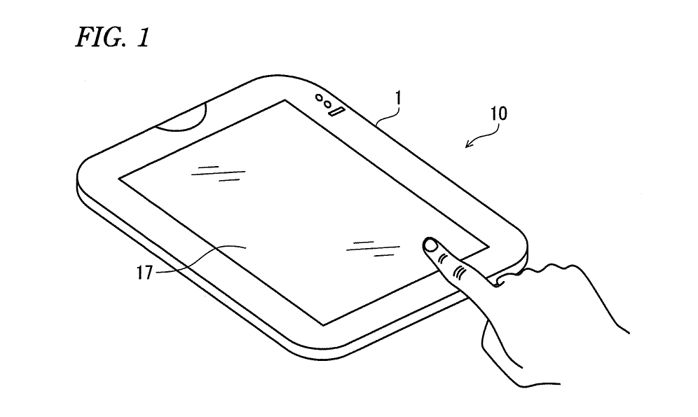

FIG. 1 is a perspective view showing an example of external appearance of an electronic device in this embodiment.

The electronic device in this embodiment is a portable electronic device. For example, the electronic device is implemented as a tablet computer 10. Alternatively, the electronic device may be implemented as a notebook type personal computer, a smartphone, a PDA, etc., or may be implemented as a DTV (Digital Television), etc.

The tablet computer 10 has a computer body 1, and a touch screen display 17. The computer body 1 has a housing shaped like a thin box. The touch screen display 17 is disposed on the surface of the computer body 1. The touch screen display 17 has a flat panel display (such as a liquid crystal display device (LCD)), and a touch panel. The touch panel is provided to cover a screen of the flat panel display. The touch panel is configured to detect a position (coordinates) touched with a user's finger or a pen on the touch screen display 17.

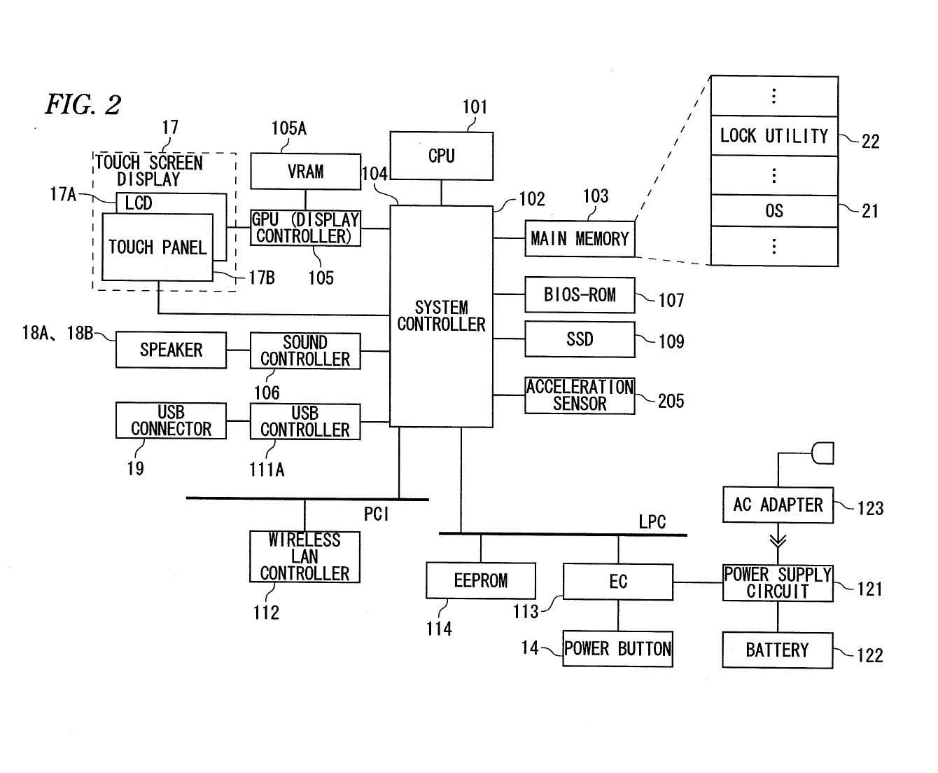

The outline of system configuration of the electronic device in this embodiment will be described below with reference to FIG. 2.

FIG. 2 is a block diagram showing an example of system configuration of the electronic device according to this embodiment.

The tablet computer 10 has a central processing unit (CPU) 101, a system controller 102, a main memory 103, a graphics controller (GPU) 105, a sound controller 106, a BIOS-ROM 107, a solid-state drive (SSD) 109, a wireless LAN controller 112, an embedded controller (EC) 113, an EEPROM 114, a USB connector 13, a touch screen display 17, a video memory (VRAM) 105A, an acceleration sensor 205, etc.

The CPU 101 is a processor which controls operation of respective portions in the tablet computer 10. The CPU 101 executes an operating system (OS) 21 and various application programs loaded from the SSD 109 onto the main memory 103. The application programs include a lock utility program 22. Incidentally, the lock utility program 22 may be a program included in the OS 21.

The CPU 101 further executes a BIOS (basic input/output system) stored in the BIOS-ROM 107. The BIOS is a program for hardware control.

The system controller 102 is a bridge device which connects respective devices on a PCI (Peripheral Component Interconnect) bus and respective devices on an LPC (Low Pin Count) bus to a local bus of the CPU 101. The system controller 102 has a built-in IDE (Integrated Drive Electronics) controller for controlling the SSD 109. The system controller 102 further has a function of executing communication with the sound controller 106. The system controller 102 further has a function of executing communication with the GPU 105 through a PCI EXPRESS standards-based serial bus or the like.

The GPU 105 is a display controller which controls an LCD 17A used as a display monitor of the tablet computer 10. A video signal (referred to as display signal) generated by the GPU 105 is fed to the LCD 17A.

The sound controller 106 is a sound source device which outputs audio data to be reproduced, to speakers 18A and 18B. The wireless LAN controller 112 is a wireless communication device which executes wireless communication, for example, based on IEEE 802.11 standards.

The EC 113 is an embedded controller for power management. The EC 113 has a function of powering on/off the tablet computer 10 in accordance with user's operation. A power supply circuit 121 generates operating power to be supplied to respective components of the tablet computer 10 by using power fed from a battery 122 in the tablet computer 10 or power fed from an external power supply such as an AC adapter 123. The power supply circuit 121 further charges the battery 122 by using power fed from the external power supply.

In addition to the LCD 17A, a touch panel 17B is incorporated in the touch screen display 17. The touch panel 17B which is disposed so as to be piled on the LCD 17A has a sensor, an MCU (Micro Controller Unit), etc. When a touch operation on the touch panel 17B is performed, the touched position is detected by the sensor so that input information including the touched position (coordinates) on the touch panel 17B is outputted from the MCU.

The video memory (VRAM) 105A is connected to the graphics controller 105. For example, the video memory (VRAM) 105A stores screen image data corresponding to a screen image displayed on an external display or the LCD 17A.

The acceleration sensor 205 is a sensor module capable of detecting acceleration. The acceleration sensor 205 can detect the attitude of the body 1 of the tablet computer 10 by detecting gravitational acceleration. The term “detection of the attitude” mentioned herein includes detection as to whether the body 1 is placed lengthways (whether the longitudinal direction of the body 1 is vertical), whether the body 1 is placed sideways (whether the longitudinal direction of the body 1 is horizontal) or how the body 1 is inclined with respect to the vertical direction.

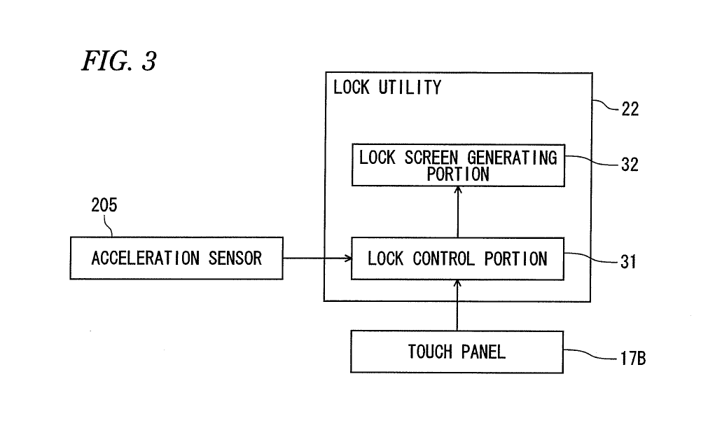

FIG. 3 is a block diagram showing an example of functional configuration in this embodiment.

A lock control portion 31 has a function of generally controlling the lock function. When, for example, there is no user's operation input for a fixed time, the lock control portion 31 executes a lock process on the tablet computer 10. The lock process is a process of disabling a greater part of functions of the tablet computer 10 unless a predetermined operation input is made. While the tablet computer 10 is not unlocked (while the tablet computer 10 is locked), a screen for unlocking the tablet computer 10 is displayed. In this embodiment, when the tablet computer 10 is locked, the user can unlock the tablet computer 10 by tracing a predetermined locus or by touching a predetermined position. When the tablet computer 10 is unlocked, a home screen (screen for ordinary operation of the tablet computer 10) is displayed in the tablet computer 10 so that the user can execute almost all the functions of the tablet computer 10.

A lock screen generating portion 32 has a function of generating a screen for unlocking the tablet computer 10 (hereinafter also referred to as unlock screen) and an image for an unlock input setting process. The unlock screen is generated by the lock screen generating portion 32 based on a layout determined by the lock control portion 31. When the unlock screen is displayed in the tablet computer 10, the user can unlock the table computer 10 by tracing/touching a predetermined position on the screen of the touch panel 17B based on this screen. In this embodiment, the display form of the unlock screen is changed at random (the display form of the image as a reference of the position of the touch input varies between first display timing and second display timing).

When the unlock screen is displayed on the LCD 17A by the lock screen generating portion 32, the user can make an operation input for unlocking the tablet computer 10 based on the display. On this occasion, the touch panel 17B detects the user's touch position (coordinates), and the lock control portion 31 determines whether the touch position is coincident with (corresponds to/is approximately consistent with) a predetermined unlock position or not. When the touch position is coincident with the predetermined unlock position (coordinates), the lock control portion 31 unlocks the tablet computer 10 so that a home screen is displayed in the tablet computer 10.

In addition, the lock control portion 31 and the lock screen generating portion 32 function as a lock controller and an unlock screen display controller.

The unlock screen displayed in the tablet computer 10 will be described below.

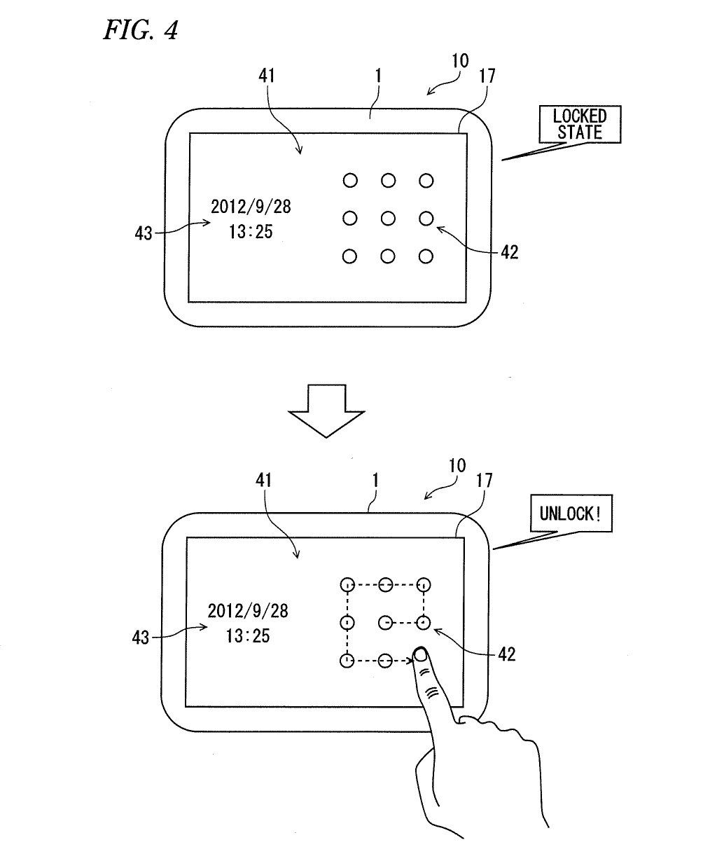

FIG. 4 is a conceptual view showing an example of the unlock process in this embodiment.

A default (initial) unlock screen is displayed in FIG. 4. The unlock screen 41 displayed on the LCD 17A of the touch screen display 17 includes an unlock pattern 42 and a time indication 43.

The unlock pattern 42 (unlock design) is a reference (indexical) image which is displayed for a touch input to unlock the tablet computer 10 and which is hereinafter referred to as unlock input reference image.

When the tablet computer 10 is locked (shifted to the locked state) by the lock control portion 31, the unlock screen 41 is displayed on the LCD 17A. The user can unlock the tablet computer 10 based on the unlock pattern 42 by tracing a predetermined locus on the unlock pattern 42 in the locked state (e.g. a locus represented by the broken line in FIG. 4B). The predetermined locus can be set by the user at the time of lock setting.

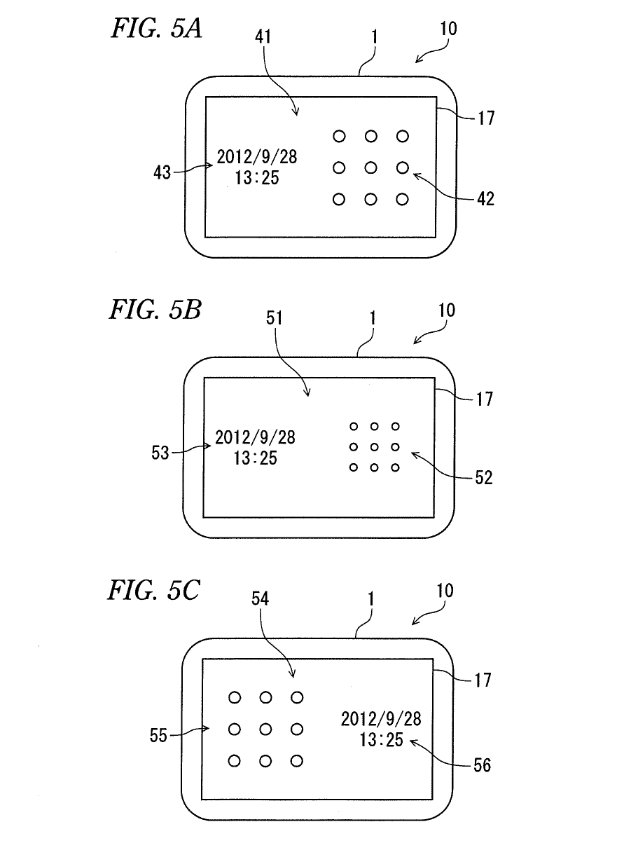

In the tablet computer 10 in this embodiment, a plurality of display patterns for the unlock screen 41 can be set so that one of the display patterns can be displayed at random. Various display examples of the unlock screen are shown below in FIGS. 5A to 5C, FIGS. 6A to 6C, FIGS. 7A to 7C and FIGS. 8A and 8B.

FIGS. 5A to 8B are conceptual views showing examples of the unlock screen in this embodiment.

FIG. 5A is a view showing the unlock screen 41 at the time of default display. In FIG. 5A, the tablet is placed sideways, so that the unlock pattern 42 with a predetermined size is displayed on the right side of the screen of the LCD 17A while the time indication 43 is displayed on the left side of the screen.

FIG. 5B is a view showing an unlock screen 51 in the case where the display of the unlock pattern 42 is set to be smaller than the default display. An unlock pattern 52 in FIG. 5B is displayed to be smaller than the unlock pattern 42 of the default display, so that a locus (touch place) of user's touch for unlocking the tablet computer 10 is different from the locus in default display. In this manner, because it is impossible to unlock the tablet computer 10 even if the same locus as in default display is touched, it is impossible to unlock the tablet computer 10 even if fingerprints left on the touch screen display 17 by user's operation at the time of default display are touched by another user. Accordingly, security performance is improved.

FIG. 5C is a view showing an unlock screen 54 in the case where the display position of the unlock pattern 42 is set to be different from default display. In FIG. 5C, an unlock pattern 55 is displayed on the left side of the screen of the LCD 17A while a time indication 56 is displayed on the right side of the screen. In this manner, when the position, size or the like of the unlock pattern 55 is changed, the position, size or the like of another indication (e.g. time indication) displayed in another region than the unlock pattern 55 may be changed based on the display of the unlock pattern 55.

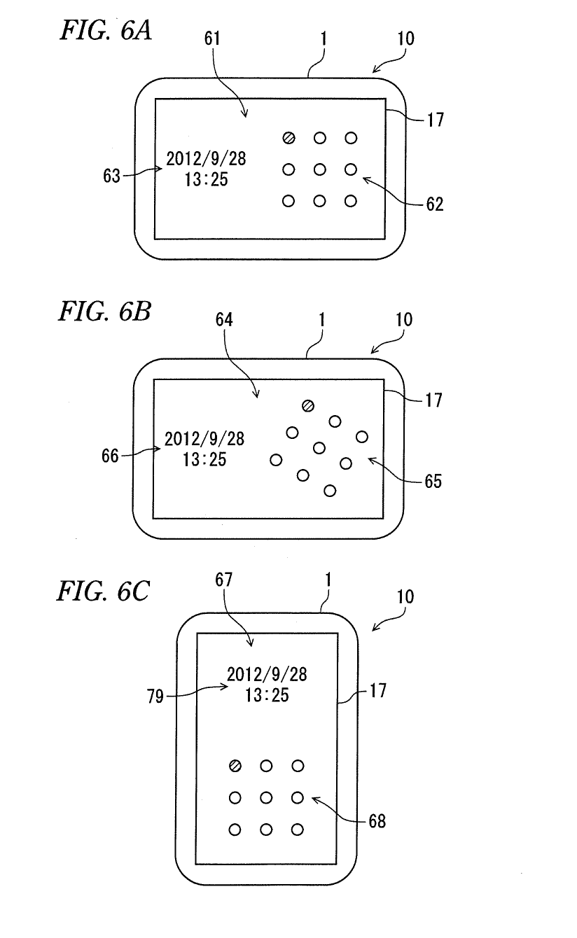

FIG. 6A is a view showing an unlock screen 61 in the case where a part of an unlock pattern 62 is displayed in a different form than that of the other part. In FIG. 6A, an upper left one of nine spots in the unlock pattern 62 is displayed in a color different from the color of the other spots. In this case, because the unlock pattern is not a point-symmetrical image with respect to the center, the user can recognize the top, bottom, left and right of the unlock pattern easily. In this manner, a figure not point-symmetrical with respect to the center may be used as the image in order to make the user recognize the top, bottom, left and right easily. Although only the upper left spot is displayed in a different color in this embodiment, the invention is not limited thereto. For example, a plurality of spots may be displayed in a different color. For example, each spot may be displayed not as a circular figure but as another different figure such as a star-shaped figure.

FIG. 6B is a view showing an unlock screen 64 in the case where a displayed angle of an unlock pattern 65 is different from that of the default display. The display of the unlock pattern 65 in FIG. 6B is inclined with respect to the default display. Since one of spots in the unlock pattern 65 is displayed so as to be differentiated from the other spots here, the user can recognize the top, bottom, left and right of the unlock pattern 65 easily even if the display of the unlock pattern 65 is inclined (even if the angle of the unlock pattern 65 is different or the unlock pattern 65 is rotated).

FIG. 6C is a view showing an unlock screen 67 in the case where the tablet computer 10 placed vertically is used. On the unlock screen 67, an unlock pattern 68 is displayed on the lower side of the screen of the LCD 17A while a time indication 69 is displayed on the upper side of the screen. When the vertical attitude of the tablet computer 10 (the longitudinal direction of the housing is upward) is detected based on the result of acceleration detection by the acceleration sensor 205, the lock control portion 31 displays the unlock pattern 68 on the lower side of the screen of the LCD 17A and displays the time indication 69 on the upper side of the screen as shown in the unlock screen 67. Also in this case, the position of the unlock pattern 68 and the position of the time indication 69 may be displayed in place of each other as shown in FIG. 5C. Also in FIG. 6C, because one of spots in the unlock pattern 68 is displayed so as to be differentiable from the other spots, the user can recognize up, down, left and right directions of the unlock pattern 68 easily. When the direction of display of the unlock pattern 68 is changed in accordance with the direction of the tablet computer 10 as shown in FIG. 6C to thereby display the unlock pattern 68 in the same position as in the case where the tablet computer 10 is placed sideways, the locus of touch for unlocking the tablet computer 10 varies to make it more difficult for another user to estimate the locus of unlock touch based on fingerprints.

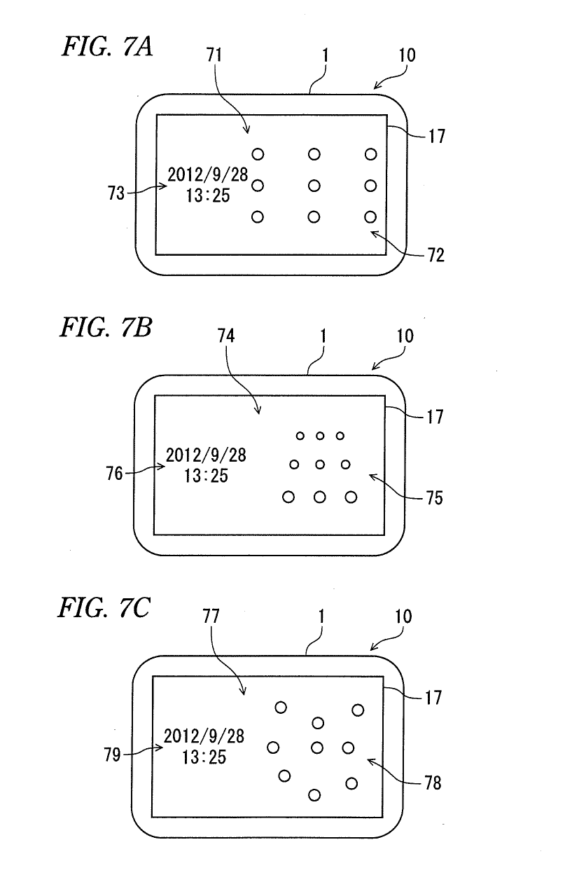

FIG. 7A is a view showing an unlock screen 71 in the case where the shape of an unlock pattern 72 is different from default display. In FIG. 7A, the lateral distance between adjacent ones of spots in the unlock pattern 72 becomes long compared with the default display. When the shape is changed in this manner, it becomes difficult to estimate the locus of unlock touch based on fingerprints.

FIG. 7B is a view showing an unlock screen 74 in the case where the shape of an unlock pattern 75 is different from default display. FIG. 7B shows an example in which the shape of the unlock pattern 75 changes according to the attitude of the tablet computer 10. For example, when only the upper portion of the screen is raised up to incline the screen from a state where the tablet computer 10 is placed as horizontally as on a desk with the LCD 17A faced up, the unlock screen 74 displays the unlock pattern 75 as shown in FIG. 7B. A flow of display change will be described in sequence as follows. When the tablet computer 10 is initially placed horizontally, a default unlock pattern as shown in FIG. 5A is displayed. When only the upper portion of the screen of the tablet computer 10 is then raised up so that the attitude of the tablet computer 10 is inclined with respect to the horizontal direction, the spot size in the unlock pattern 75 decreases and the lateral distance between adjacent spots in the unlock pattern 75 decreases as the spot position goes up. This is such display that the stereoscopic position of the unlock pattern initially arranged horizontally is kept as it is, and that a feeling is given to the user as if the user looked at this over an edge of the inclined tablet. That is, the tablet computer 10 detects the attitude of itself by using the acceleration sensor 205 and changes the display of the unlock pattern (or unlock screen) based on the detected attitude. In this manner, because the display of the unlock screen is changed according to the attitude of the tablet computer 10 so that the user performs unlock inputting of various loci naturally, security is improved.

FIG. 7C is a view showing an unlock screen 77 in the case where the shape of an unlock pattern 78 is different from default display. The unlock pattern 78 in FIG. 7C is displayed while deformed so that the user can recognize the correspondence of spots in the unlock pattern 78 to spots in the default unlock pattern.

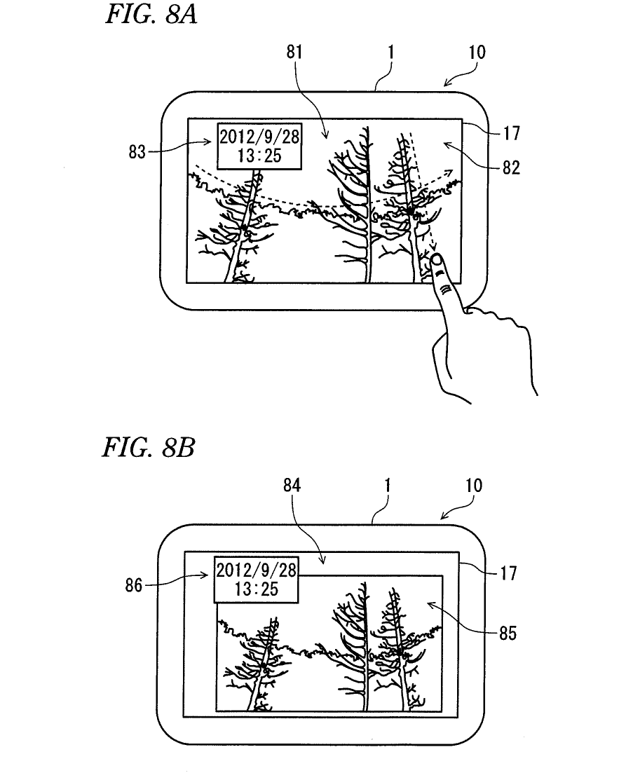

FIG. 8A is a view showing an unlock screen 81 on which not an unlock pattern but an unlock picture 82 is displayed. Although the case where an image of a predetermined pattern (design) is used as an example of the unlock input reference image displayed as a reference (index) for an unlock touch input has been described so far, the case where a predetermined picture (image) is used will be described here. The unlock screen 81 includes an unlock picture 82 and a time indication 83. The user can unlock the tablet computer 10 by tracing a predetermined locus (position) on the unlock picture 82 with a user's finger (e.g. a locus represented by the broken line in FIG. 8A). This locus can be set by the user at the time of lock setting.

FIG. 8B is a view showing an unlock screen 84 on which an unlock picture 85 is displayed without full-screen display. The unlock picture 85 in FIG. 8B is different in size and center position from the unlock picture 82 in FIG. 8A. The locus touched by the user for unlocking the tablet computer 10 is different from the locus in the unlock screen 81 in FIG. 8A. In this manner, security is improved.

Although various examples about the method of displaying the unlock pattern or unlock picture 82 of the unlock input reference image displayed as a reference (index) for an unlock touch input have been described so far, display may be changed by another manner than the aforementioned examples so that the locus of user's touch can be changed every time. Display may be performed by combination of these. For example, the unlock pattern may be displayed while the position, size, inclination (angle) and shape are differentiated respectively from those in the default unlock pattern or the position, size, inclination, shape, etc. of the unlock pattern may be changed respectively based on the attitude of the tablet computer 10.

Processing executed by the tablet computer 10 will be described below.

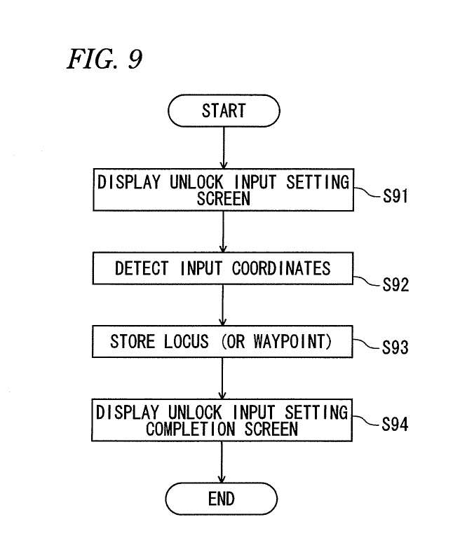

FIG. 9 is a flow chart showing an example of an unlock input setting process in this embodiment.

First, the lock control portion 31 instructs the lock screen generating portion 32 to generate a screen for setting a locus (position/coordinates) of user's touch on the touch panel 17B for unlocking the tablet computer 10, and the lock screen generating portion 32 displays a locus input screen (unlock input setting screen) for unlocking the tablet computer 10 (step S91). The unlock input setting screen may be approximately the same as the default unlock screen or may be a screen to which display of a message “Input an unlock locus.” is further added.

Then, the touch panel 17B detects coordinates of the user input (coordinates of the user's traced locus/position) (step S92), and transmits the coordinate information to the lock control portion 31.

Upon reception of the input coordinates, the lock control portion 31 stores a locus of the input coordinates or a part or all of positions of the input coordinates, and registers this as unlock input coordinates (step S93).

Then, the lock control portion 31 instructs the lock screen generating portion 32 to display an unlock input setting completion screen as a screen indicating completion of the unlock input setting (step S94), and the unlock input setting process is terminated.

The lock control portion 31 may store continuously or intermittently the locus of unlock input coordinates traced by the user. When the locus is stored intermittently, for example, the coordinates may be stored as coordinates of each spot in an unlock pattern (e.g. center->right->upper right-> . . . etc.).

The unlock process will be described below.

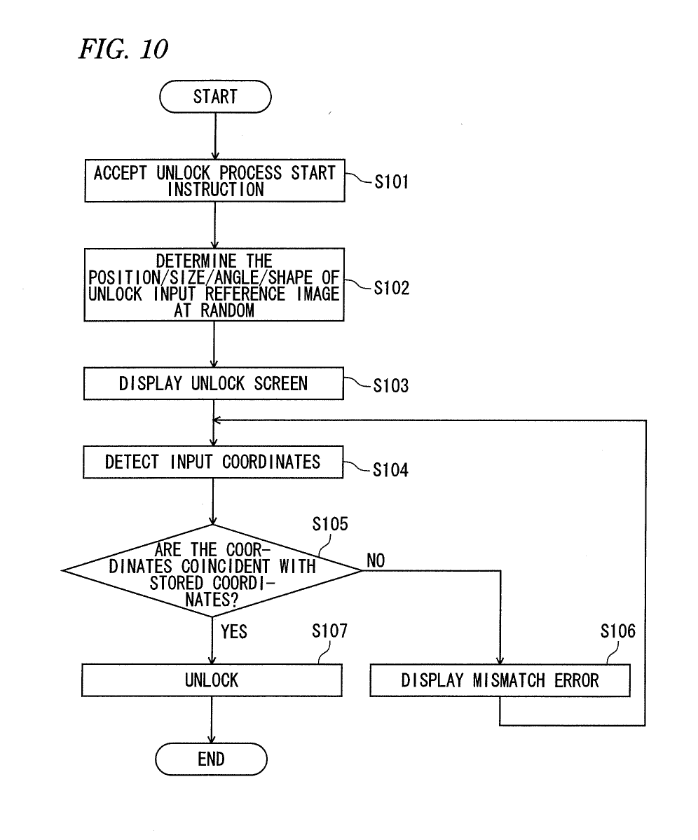

FIG. 10 is a flow chart showing an example of the unlock process in this embodiment.

When the lock control portion 31 accepts an unlock process start instruction from the user, for example, by pushing down a power button 14 etc. after shifting the tablet computer 10 to a locked state (step S101), the lock control portion 31 determines the position/size/angle/shape of the displayed unlock input reference image (unlock pattern or unlock picture) at random (step S102). On this occasion, the display form of the unlock input reference image may be determined by random combination using random numbers etc. for the respective items of position/size/angle/shape. The unlock input reference image may be determined by FIG. 6C or 7B or combination of these based on the result of the attitude of the body 1 detected by the acceleration sensor 205. The lock control portion 31 determines not only the display form of the unlock input reference image (unlock pattern or unlock picture) but also the display form (displayed position/size/angle/shape) of the time indication, and determines the display form of the whole unlock screen.

When the lock control portion 31 determines the display form of the whole unlock screen, the lock screen generating portion 32 displays the unlock screen on the LCD 17A based on the determination (step S103).

When the touch panel 17B then detects a user's touch input (step S104), the lock control portion 31 determines whether the inputted coordinates are coincident (approximately coincident) with the stored (registered) coordinates or not (step S105). On this occasion, because the display form has been changed, the tablet computer 10 cannot be unlocked correctly when the inputted coordinates are directly compared with the stored coordinates. The lock control portion 31 calculates (converts) coordinates which should be inputted, based on the form of the unlock input reference image, and determines whether the inputted coordinates are coincident with the calculated coordinates or not, based on the calculated coordinates.

When determination in the step S105 results in that the inputted coordinates are not coincident with the stored coordinates (converted coordinates) (step S105: No), the lock control portion 31 instructs the lock screen generating portion 32 to generate and display a message indicating the fact that the tablet computer 10 cannot be unlocked because the coordinates are not coincident (step S106).

When determination in the step S105 results in that the inputted coordinates are coincident with the stored coordinates (converted coordinates) (step S105: Yes), the lock control portion 31 unlocks the tablet computer 10 and shifts the screen of the tablet computer 10 to a home screen (step S107). On this occasion, the lock control portion 31 may display a message indicating success in unlocking the tablet computer 10 before shifting the screen to a home screen.

In the tablet computer 10 according to this embodiment, an image as a reference of a touch input for unlocking the tablet computer 10 is changed and coordinates which should be inputted are converted in accordance with the change of the image. Accordingly, even if another user intends to unlock the tablet computer 10 by tracing user's fingerprints left on the screen of the tablet, the table computer 10 cannot be unlocked so that the possibility of another user's unlocking the tablet computer 10 illegally is reduced. That is, the security performance of the tablet computer 10 is improved.

To cope with illegal unlock based on fingerprints, the user need change the unlock input diligently. However, because the tablet computer 10 according to this embodiment is designed so that display is changed automatically, the user's labor for doing the change can be reduced.

Although the user traces a locus on the screen and determination as to whether unlocking is successful or not is made based on the locus in the aforementioned embodiment, the invention is not limited thereto. For example, configuration may be made so that the user can perform unlocking by touching a plurality of predetermined positions. Also in this case, because user's fingerprints are left on the screen, the same effect as in the aforementioned embodiment can be expected.

Incidentally, the invention is not limited to the aforementioned embodiments precisely and constituent elements may be variously modified and embodied in the practical stage without departing from the gist of the invention. Constituent elements disclosed in the aforementioned embodiments may be combined suitably to form various inventions. For example, some constituent elements may be removed from all constituent elements disclosed in each embodiment. In addition, constituent elements disclosed in different embodiments may be combined suitably.

What is claimed is:

1. An electronic device comprising:
a display;
a touch panel provided on the display;
a lock controller configured to shift the electronic device to a locked state and configured to cancel the locked state when a touch input in a predetermined position of the touch panel is detected; and
an unlock screen display controller configured to generate an image as a reference of the position of the touch input for cancellation of the locked state, display the image on the display, and control a display form of the image so that the display form corresponding to a first timing is different from the display form corresponding to a second timing.

2. The electronic device according to claim 1, wherein
the unlock screen display controller controls a position of the image as the display form.

3. The electronic device according to claim 1, wherein
the unlock screen display controller controls positions of the image and other objects displayed on the display as the display form.

4. The electronic device according to claim 1, wherein
the unlock screen display controller controls a size of the image as the display form.

5. The electronic device according to claim 1, wherein
the unlock screen display controller controls an angle of the image as the display form.

6. The electronic device according to claim 1, wherein
the unlock screen display controller controls a shape of the image as the display form.

7. The electronic device according to claim 1, wherein
the unlock screen display controller controls at least two of a position, a size, an angle and a shape of the image as the display form.

8. The electronic device according to claim 1, further comprising:
a detection unit configured to detect an attitude of the electronic device; wherein
the unlock screen display controller controls the display form of the image according to a result detected by the detection unit.

9. A recording medium configured to store a program executed in an electronic device equipped with a display and a touch panel provided on the display, comprising:
shifting the electronic device to a locked state;
cancelling the locked state when a touch input in a predetermined position of the touch panel is detected;
generating an image as a reference of the position of the touch input for cancellation of the locked state and displaying the image on the display portion; and
controlling a display form of the image so that the display form corresponding to a first timing is different from the display form corresponding to a second timing.

10. A lock control method comprising:
shifting the electronic device to a locked state;
generating an image as a reference of a position of a touch input on a touch panel for cancellation of the locked state and displaying the image on the display;
controlling a display form of the image so that the display form corresponding to a first timing is different from the display form corresponding to a second timing; and
canceling the locked state when a touch input in a predetermined position of the touch panel is detected.
